(19) United States
(12) Patent Application Publication
(10) Pub. No.: US 2022/0339679 A1
(43) Pub. Date: Oct. 27, 2022

(54) MULTIFUNCTIONAL CLEANING PEN FOR CLEANING DELICATE AND FRAGILE OBJECTS, AND METHOD FOR PEN IN CLEANING OBJECTS

(71) Applicant: TRIPLE WIN TECHNOLOGY(SHENZHEN) CO.LTD., Shenzhen (CN)

(72) Inventors: AN-CHANG LEI, New Taipei (TW); CHEN-WEI CHEN, New Taipei (TW); HONG ZHANG, Shenzhen (CN)

(21) Appl. No.: 17/728,055

(22) Filed: Apr. 25, 2022

(30) Foreign Application Priority Data
Apr. 26, 2021 (CN) 202110454609.6

(51) Int. Cl. B08B 13/00; H04N 7/18; G06T 7/00; B08B 5/04; B08B 5/02; B08B 1/00; B08B 3/08

(52) U.S. Cl. CPC B08B 13/00; H04N 7/183; G06T 7/0002; B08B 5/04; B08B 5/02; B08B 1/006; B08B 3/08; G06T 2207/30168

(57) ABSTRACT

A multifunctional cleaning pen and a method for cleaning an object are disclosed. The cleaning pen includes a main body, a pen head assembly, an air supply assembly, and a control assembly. The pen head assembly can lift or adsorb a target object for examination onto a platform by a vacuum through the pen, avoiding physical contact with the object by hard tools.

The air supply assembly is inside the main body and the control assembly is on a surface of the main body. When the object is in place, it can be cleaned by a jet of air forced out of the pen, and also by a vibrated alcohol wiper on the pen. By utilizing the multifunctional cleaning pen, a cleaning effect in relation to fragile and delicate materials such as camera, mobile phone speaker, and card tray, is improved.

### FIELD

The present application relates to a technology field of object cleaning, and more particularly to a multifunctional cleaning pen and a method for cleaning objects using the multifunctional cleaning pen.

### BACKGROUND

Cleaning fine and delicate objects can be done manually by using tweezers and cotton swabs. However, such a method is time-consuming and inefficient. If the cleaning is not thorough, stains and other residues may remain on the objects, and the use of objects may be affected.

### BRIEF DESCRIPTION OF THE DRAWINGS

FIG. 1 is a schematic structural diagram of a multifunctional cleaning pen of the present disclosure.

FIG. 2 is a flowchart of a method for cleaning objects using the pen in an embodiment of the present disclosure.

### DETAILED DESCRIPTION

The accompanying drawings combined with the detailed description illustrate the embodiments of the present application hereinafter. It is noted that embodiments of the present disclosure and features of the embodiments can be combined, when there is no conflict.

Various details are described in the following descriptions for a better understanding of the present application, however, the present application may also be implemented in other ways other than those described herein. The scope of the present application is not to be limited by the specific embodiments disclosed below. Unless defined otherwise, all technical and scientific terms used herein have the same meaning as commonly understood by one of ordinary skill in the art to which the present application belongs. The terms used herein in the present application are only for the purpose of describing specific embodiments and are not intended to limit the present disclosure.

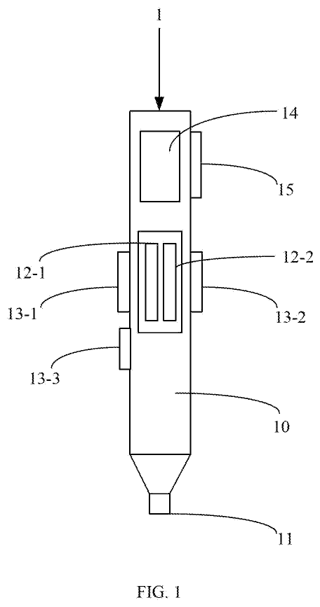

FIG. 1 is a multifunctional cleaning pen in an embodiment of the present application. As shown in FIG. 1, a multifunctional cleaning pen includes a main body 10, a pen head assembly 11, an air supply assembly 12, and a control assembly 13. The pen head assembly 11 is detachably mounted on one end of the main body 10, the air supply assembly 12 is configured inside the main body 10, and the control assembly 13 is configured on a surface of the main body 10. In one embodiment, the control assembly 13 controls the multifunctional cleaning pen to adsorb a target object by controlling the air supply assembly 12 to perform a suction operation through the pen head assembly 11, or controls the multifunctional cleaning pen to blow air onto the target object by controlling the air supply assembly 12 to perform a blowing operation through the pen head assembly 11.

In one embodiment, the target object can be a fine material that needs to be cleaned, such as cameras and speakers of mobile phone, or a card tray, for example.

In one embodiment, the main body 10 is a main component to accommodate the multifunctional cleaning pen 1, such as the air supply assembly 12. A shape of the main body 10 can be adjusted according to actual requirements of consumers; it is not limited in embodiments of the present application.

In one embodiment, the pen head assembly 11 includes a suction pen head 11-1, a blowing pen head 11-2 and an alcohol wiping pen head 11-3. In one embodiment, the suction pen head 11-1, the blowing pen head 11-2 and the alcohol wiping pen head 11-3 are detachably mounted on one end of the main body 10 according to the actual requirements. In a first embodiment, when the user needs to use the multifunctional cleaning pen 1 to absorb a target object, the suction pen head 11-1 can be mounted on one end of the main body 10. In a second embodiment, when the user needs to use the multifunctional cleaning pen 1 to blow and clean the target object by air jet, the blowing pen head 11-2 can be mounted on one end of the main body 10. In a third embodiment, when the user needs to use the multifunctional cleaning pen 1 to wipe the target object, the alcohol wiping pen head 11-3 can be mounted on one end of the main body 10.

In one embodiment, the air supply assembly 12 includes a suction device 12-1 and a blowing device 12-2. The suction device 12-1 provides a suction function, and the blowing device 12-2 provides a blowing function.

In one embodiment, the control assembly 13 includes a suction button 13-1 and a blowing button 13-2. The suction button 13-1 controls the suction device 12-1 to perform a suction operation through the suction pen head 11-1, the blowing button 13-2 controls the blowing device 12-2 to perform a blowing operation through the blowing pen head 11-2. For example, when the user needs to use the multifunctional cleaning pen 1 to blow an air jet and clean the target object, the blowing pen head 11-2 is mounted on one end of the main body 10. When the blowing button 13-2 is pressed, the blowing device 12-2 is activated to force air out through the blowing pen head 11-2 for cleaning the object.

In at least one embodiment, the multifunctional cleaning pen 1 further includes a vibration motor 14 and a vibration motor switch 15. The vibration motor 14 is installed above the air supply assembly 12, and the alcohol wiping pen head 11-3 is controlled by the vibration motor switch 15 to perform a cleaning operation on the target object by wiping with alcohol. For example, when the user needs to perform alcohol wiping on the target object, the alcohol wiping pen head 11-3 can be installed on one end of the main body 10, and after the vibration motor switch 15 is pressed, the alcohol wiping pen head 11-3 performs an alcohol wiping cleaning operation on the target object.

In at least one embodiment, the control assembly 13 further includes an air pressure adjustment knob 13-3, which adjusts air pressure of the air supply assembly 12. A surface of the air pressure adjustment knob 13-3 is provided with an air pressure scale, when the user rotates the air pressure adjustment knob 13-3, internal air pressure of the air supply assembly 12 is adjusted according to a change of the air pressure scale. The user can adjust according to actual requirements. By adjusting the internal air pressure of the air supply assembly 12, the adsorption function and the blowing cleaning function of the multifunctional cleaning pen 1 can both be changed according to actual situation of the target object, so as to achieve a better cleaning effect.

By utilizing the multifunctional cleaning pen 1 to clean fine materials, small materials can be cleaned easily and efficiently, the cleaning effect can be improved when compared with traditional tools (e.g., tweezers or cotton swabs).

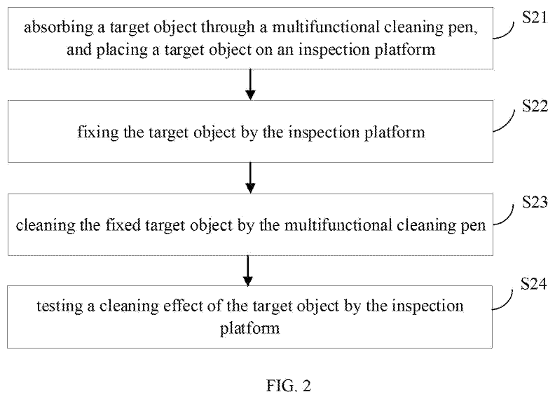

FIG. 2 is a flowchart of a method for cleaning objects with the pen in an embodiment of the present application. As shown in FIG. 2, the method for cleaning the object can be applied in the electronic device 1. According to different requirements, an order of blocks shown in this flowchart can be changed, or can be omitted. In one embodiment, the method of cleaning the object includes:

In block S21, a multifunctional cleaning pen absorbs a target object, and places the target object on an inspection platform.

In one embodiment, the inspection platform includes a display screen, an image sensor lens, a fixed plate, a position adjustment knob, and a position control button. The fixed plate is located below the image sensor lens. The position control button and the position adjustment knob can fix the target object in place by adjusting a position of the fixed plate. The image sensor lens captures an image of a target object, and the display screen displays the image.

In one embodiment, the multifunctional cleaning pen 1 controls the suction pen head 11-1 to absorb the target object by pressing the suction button 13-1 of the multifunctional cleaning pen 1. The target object is moved using the multifunctional cleaning pen 1, and then placed on the fixed plate by releasing the suction button 13-1 of the multifunctional cleaning pen 1.

In one embodiment, the user may install the suction pen head 11-1 on one end of the main body 10, then align the suction pen 11-1 with the target object, and press the suction button 13-1. The suction device 12-1 can trigger a suction function, and the target object is absorbed by the suction pen head 11-1. After the multifunctional cleaning pen 1 adsorbs the target object, the target object can be placed on the fixed plate by moving the multifunctional cleaning pen 1.

By utilizing the suction device 12-1 of the multifunctional cleaning pen 1 to absorb an object and place the object on the inspection platform, compared with a method for using tweezers and clips to move the object, the method for adsorbing the object avoids damage to the object by physical contact with hard tool materials, or damage by improper manual operation.

In block S22, the target object is fixed on the inspection platform.

By fixing the target object on the inspection platform, movement of the target object when cleaning the target product is prevented.

In one embodiment, the target object can be fixed by adjusting the position of the fixed plate through the position control button; or the target object can be fixed by adjusting the position of the fixed plate through the position adjustment knob.

For example, the user uses the position control button to input the preset position coordinates, the fixed plate automatically adjusts the position according to the position coordinates, and adjusts the fixed plate to fix the target object on the inspection platform. The user may rotate the position adjustment knob until the target object is fixed by the fixed plate.

In one embodiment, the user selects the position adjustment knob and/or the position control button according to actual needs, which is not limited herein.

By fixing the target object, it is convenient to use the multifunctional cleaning pen 1 to clean the object, and the cleaning effect can be improved.

In block S23, a multifunctional cleaning pen cleans the fixed target object.

In one embodiment, the blowing button 13-2 of the multifunctional cleaning pen 1 controls the blowing pen head 11-2 to blow out an air jet and clean the target object, and the vibration motor switch 15 of the multifunctional cleaning pen 1 controls the alcohol wiping pen head 11-3 to perform a cleaning operation on the target object.

For example, the user installs the blowing tip 11-2 on one end of the main body 10, then aligns the blowing pen head 11-2 with the target object, and presses the blowing button 13-2. After the blowing device 12-2 is pressed, a blowing function is invoked to force air out through the blowing pen head 11-2 for cleaning the target object. For another example, the user installs the alcohol wiping pen head 11-3 on one end of the main body 10, then aligns the alcohol wiping pen head 11-3 with the target object, and presses the vibration motor switch 15. Through the alcohol wiping pen head 11-3, the multifunctional cleaning pen 1 performs an alcohol wiping cleaning operation on the target object.

Compared with a manual cleaning method with a cotton swab, the cleaning method can clean both a surface of the target object and interior of crevices of the target object. At the same time, the alcohol wiping pen head is driven by a vibrating motor to perform an alcohol wiping on the target object to improve the cleaning effect.

In block S24, an inspection platform tests cleanliness of the target object.

In one embodiment, the image sensor lens captures a target image of the target object, and uploads and displays the target image on the display screen. The image sensor inputs the target image to a pre-trained image detection model. The pre-trained image detection model outputs a result of cleanliness analysis in relation to the target image, and determines a cleaning effect of the target object according to the result.

In one embodiment, when the result is pass, the cleaning effect of the target object is determined to be good, and a passed or cleaned prompt is output. When the result is not pass, the cleaning effect of the target object is determined to be insufficient, and a fail prompt is output.

In at least one embodiment, after uploading the target image to the display screen, the user may determine directly whether the target image indicates a pass.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A multifunctional cleaning pen comprising:
a main body;
a pen head assembly detachably mounted on one end of the main body;
an air supply assembly accommodated inside the main body;
a control assembly configured on a surface of the main body, the control assembly controlling the multifunctional cleaning pen to inhale by controlling the air supply assembly to perform a suction operation through the pen head assembly, or controlling the multifunctional cleaning pen to exhale by controlling the air supply assembly to perform a blowing operation through the pen head assembly.

2. The multifunctional cleaning pen of claim 1, wherein the pen head assembly comprises a suction pen head, a blowing pen head and an alcohol wiping pen head.

3. The multifunctional cleaning pen of claim 2, wherein the air supply assembly comprises a suction device and a blowing device.

4. The multifunctional cleaning pen of claim 3, wherein the control assembly comprises:
a suction button which controls the suction device to perform the suction operation through the suction pen head;
a blowing button which controls the blowing device to perform a blowing operation through the blowing pen head.

5. The multifunctional cleaning pen of claim 1, wherein the multifunctional cleaning pen further comprises:
a vibration motor installed above the air supply assembly and controls the alcohol wiping pen head to perform an alcohol wiping cleaning operation.

6. The multifunctional cleaning pen of claim 1, wherein the control assembly further comprises:
an air pressure adjustment knob configured to adjust air pressure of the air supply assembly.

7. A method of cleaning an object using a multifunctional cleaning pen, the multifunctional cleaning pen comprising a pen head assembly, an air supply assembly and a control assembly, the method comprising:
picking up a target object by the multifunctional cleaning pen, and releasing the target object on an inspection platform;
fixing the target object by the inspection platform;
cleaning the fixed target object by the multifunctional cleaning pen; and
testing a cleaning effect of the target object by the inspection platform.

8. The method of claim 7, wherein the inspection platform comprises a display screen, an image sensor lens, a fixed plate and a position control button, the fixed plate is located below the image sensor lens, and the position control button fixes the target object by adjusting a position of the fixed plate.

9. The method of claim 8, wherein testing the cleaning effect of the target object by the inspection platform comprises:
capturing a target image of the target object through the image sensor lens;
uploading and displaying the target image on the display screen, and inputting the target image to a pre-trained image detection model;
outputting a detection result of the target image by the pre-trained image detection model; and
determining the cleaning effect of the target object according to the detection result.

10. The method of claim 9, wherein determining the cleaning effect of the target object according to the detection result comprises:
when the detection result is qualified, determining that the cleaning effect of the target object is qualified;
when the detection result is unqualified, determining that the cleaning effect of the target object is unqualified.

11. A non-transitory storage medium having stored thereon at least one computer-readable instructions that, when executed by a multifunctional cleaning pen, causes the multifunctional cleaning pen to perform a method for cleaning an object, the multifunctional cleaning pen comprising a pen head assembly, an air supply assembly and a control assembly, the method comprising:
picking up a target object through the multifunctional cleaning pen, and releasing the target object on an inspection platform;
fixing the target object by the inspection platform;
cleaning the fixed target object by the multifunctional cleaning pen; and
testing a cleaning effect of the target object by the inspection platform.

12. The non-transitory storage medium of claim 11, wherein the inspection platform comprises a display screen, an image sensor lens, a fixed plate and a position control button, the fixed plate is located below the image sensor lens, and the position control button fixes the target object by adjusting a position of the fixed plate.

13. The non-transitory storage medium of claim 12, wherein testing the cleaning effect of the target object by the inspection platform comprises:
capturing a target image of the target object through the image sensor lens;
uploading and displaying the target image on the display screen, and inputting the target image to a pre-trained image detection model;
outputting a detection result of the target image through the pre-trained image detection model;
determining the cleaning effect of the target object according to the detection result.

14. The non-transitory storage medium of claim 13, wherein determining the cleaning effect of the target object according to the detection result comprises:
when the detection result is qualified, determining that the cleaning effect of the target object is qualified;
when the detection result is unqualified, determining that the cleaning effect of the target object is unqualified.
